(19) United States
(12) Patent Application Publication
(10) Pub. No.: US 2025/0303823 A1
(43) Pub. Date: Oct. 2, 2025

(54) METHOD AND DEVICE FOR DETECTING FAILURE OF A REFRIGERATOR

(71) Applicants: HYUNDAI MOTOR COMPANY, Seoul (KR); KIA CORPORATION, Seoul (KR)

(72) Inventors: HyeonSeob Kim, Hwaseong-si (KR); Gwangseob Kim, Hwaseong-si (KR); Sae Yong Jang, Hwaseong-si (KR); Jungmo Yu, Hwaseong-si (KR); Dokon Kim, Hwaseong-si (KR); Chan Seok Choi, Hwaseong-si (KR)

(73) Assignees: HYUNDAI MOTOR COMPANY, Seoul (KR); KIA CORPORATION, Seoul (KR)

(21) Appl. No.: 18/958,866

(22) Filed: Nov. 25, 2024

(30) Foreign Application Priority Data
Mar. 28, 2024 (KR) 10-2024-0042495

(51) Int. Cl. B60H 1/00

(52) U.S. Cl. CPC B60H 1/00978

(57) ABSTRACT

A refrigerator failure detection method and device are provided. The refrigerator failure detection method is for detecting a failure of a refrigerator installed in a vehicle. The method includes: obtaining expected current consumption of the refrigerator based on a current consumption map predefined for the refrigerator; calculating an expected cumulative power consumption based on the expected current consumption; obtaining real-time current consumption of the refrigerator through a current sensor installed in the power supply unit of the refrigerator; calculating actual cumulative power consumption based on the real-time current consumption; and comparing a difference between the expected cumulative power consumption and the actual cumulative power consumption with a predetermined error tolerance to determine whether the refrigerator is broken.

### CROSS-REFERENCE TO RELATED APPLICATION

This application claims priority to and the benefit of Korean Patent Application No. 10-2024-0042495 filed in the Korean Intellectual Property Office on Mar. 28, 2024, the entire contents of which are incorporated herein by reference.

### BACKGROUND

### (a) Field

The present disclosure relates to a method and a device for detecting a failure of a refrigerator, and more particularly, to a method and a device for detecting a failure of a refrigerator installed in a vehicle.

### (b) Description of the Related Art

A Purpose Built Vehicle (PBV) is a modular mobility vehicle, i.e., a vehicle, based on electric motorization and may refer to a means of transportation based on personalized design according to the purpose of use. In other words, a PBV, unlike general passenger vehicles, is designed and manufactured to suit a specific purpose or requirement and may be a vehicle manufactured based on a special function or purpose. Refrigeration vehicles may be special vehicles used to transport temperature-sensitive goods, such as food, pharmaceuticals, and biochemical products. Refrigeration vehicles are equipped with cooling systems that may precisely control internal temperatures to ensure that goods may maintained in proper conditions until the goods reach a destination. Such refrigeration vehicles have recently been developed based on PBVs for eco-friendly purposes. Linked solutions and services are also provided.

### SUMMARY

The present disclosure attempts to provide a method and a device that are capable of detecting a failure of a refrigerator installed in a vehicle, even while the vehicle is in operation, without relying on a refrigeration temperature sensor.

According to an example embodiment, a method for detecting a failure of a refrigerator installed in a vehicle includes obtaining expected current consumption of the refrigerator based on a current consumption map predefined for the refrigerator and calculating an expected cumulative power consumption based on the expected current consumption. The method also includes obtaining real-time current consumption of the refrigerator through a current sensor installed in the power supply unit of the refrigerator and calculating actual cumulative power consumption based on the real-time current consumption. The method further includes comparing a difference between the expected cumulative power consumption and the actual cumulative power consumption with a predetermined error tolerance to determine whether the refrigerator is broken.

In the current consumption map, a current amount required to achieve the target internal temperature of the refrigerator may be defined based on at least one of an external temperature of the refrigerator, an internal temperature of the refrigerator, a target internal temperature of the refrigerator, a type of cargo loaded into the refrigerator (i.e., the refrigerated space), or any combination thereof.

The current consumption map may be defined based on a difference between the internal temperature of the refrigerator and the external temperature of the refrigerator as an X-axis, the target internal temperature of the refrigerator as a Y-axis, and the type of cargo loaded into the refrigerator as a Z-axis.

Calculating the expected cumulative power consumption may include applying a correction factor for considering a cargo volume loaded in the refrigerator to the expected current consumption and may include calculating the expected cumulative power consumption based on the expected current consumption to which the correction factor is applied.

Calculating the expected cumulative power consumption may include calculating the expected cumulative power consumption by accumulating the expected current consumption in real time by an operating time of the refrigerator.

Calculating the actual cumulative power consumption may include calculating the actual cumulative power consumption by accumulating the real-time current consumption in real time by an operating time of the refrigerator.

The error tolerance may be obtained based on an error map for each predefined power consumption section.

In the error map for each power consumption section, an error tolerance may be defined for each cumulative power consumption section based on the cumulative power consumption of the refrigerator.

Determining whether the refrigerator is broken may include, when the difference between the expected cumulative power consumption and the actual cumulative power consumption is less than the error tolerance, determining that the refrigerator is normal.

Determining whether the refrigerator is broken may include, when the difference between the expected cumulative power consumption and the actual cumulative power consumption is greater than or equal to the error tolerance, determining that the refrigerator is broken. Determining whether the refrigerator is broken may also include outputting a notification requesting inspection of the refrigerator through a plurality of interfaces installed in the vehicle.

According to another example embodiment, a device for detecting a failure of a refrigerator installed in a vehicle executes a program code loaded in one or more memory devices through one or more processors. The program code is executed to obtain an expected current consumption of the refrigerator based on a current consumption map predefined for the refrigerator and to calculate an expected cumulative power consumption based on the expected current consumption. The program code is also executed to obtain the real-time current consumption of the refrigerator through a current sensor installed in the power supply unit of the refrigerator and to calculate the actual cumulative power consumption based on the real-time current consumption. The program code is also executed to determine whether the refrigerator is broken by comparing the difference between the expected cumulative power consumption and the actual cumulative power consumption and a predetermined error tolerance.

In the current consumption map, a current amount required to achieve the target internal temperature of the refrigerator may be defined based on at least one of an external temperature of the refrigerator, an internal temperature of the refrigerator, a target internal temperature of the refrigerator, a type of cargo loaded into the refrigerator, or any combination thereof.

The current consumption map may be defined based on a difference between the internal temperature of the refrigerator and the external temperature of the refrigerator as an X-axis, the target internal temperature of the refrigerator as a Y-axis, and the type of cargo loaded into the refrigerator as a Z-axis.

Calculating the expected cumulative power consumption may include applying a correction factor for considering a cargo volume loaded in the refrigerator to the expected current consumption and may include calculating the expected cumulative power consumption based on the expected current consumption to which the correction factor is applied.

Calculating the expected cumulative power consumption may include calculating the expected cumulative power consumption by accumulating the expected current consumption in real time by an operating time of the refrigerator.

Calculating the actual cumulative power consumption may include calculating the actual cumulative power consumption by accumulating the real-time current consumption in real time by an operating time of the refrigerator.

The error tolerance may be obtained based on an error map for each predefined power consumption section.

In the error map for each power consumption section, an error tolerance may be defined for each cumulative power consumption section based on the cumulative power consumption of the refrigerator.

Determining whether the refrigerator is broken may include, when the difference between the expected cumulative power consumption and the actual cumulative power consumption is less than the error tolerance, determining that the refrigerator is normal.

Determining whether the refrigerator is broken may include, when the difference between the expected cumulative power consumption and the actual cumulative power consumption is greater than or equal to the error tolerance, determining that the refrigerator is broken. Determining whether the refrigerator is broken may also include outputting a notification requesting inspection of the refrigerator through a plurality of interfaces installed in the vehicle.

### BRIEF DESCRIPTION OF THE DRAWINGS

The drawings provided herewith illustrate one or more examples or embodiments of the disclosure and therefore should not be considered as limiting the scope of the disclosure. There may be other examples and embodiments that may be equally effective to achieve the objectives and that may fall within the scope of the disclosure. Objects, features, and advantages of the present invention will become apparent upon reading the following description in conjunction with the drawing figures.

FIG. 1 is a block diagram illustrating a refrigerator failure detection device according to an example embodiment.

FIG. 2 is a flowchart for explaining a refrigerator failure detection method according to an example embodiment.

FIG. 3 is a diagram illustrating an implementation example of a refrigerator failure detection device according to an example embodiment.

FIG. 4 is a diagram illustrating an implementation example of a refrigerator failure detection device according to an example embodiment.

FIG. 5 is a diagram illustrating an implementation example of a refrigerator failure detection device according to an example embodiment.

FIG. 6 is a diagram illustrating an implementation example of a refrigerator failure detection device according to an example embodiment.

FIG. 7 is a diagram illustrating a computing device according to an example embodiment.

### DETAILED DESCRIPTION

Hereinafter, the technical concepts of the present disclosure are described more fully hereinafter with reference to the accompanying drawings, in which example embodiments of the disclosure are shown. As those of ordinary skill in the art should realize, the described example embodiments may be modified in various different ways, all without departing from the spirit or scope of the disclosure. Accordingly, the drawings and description are to be regarded as illustrative in nature and not restrictive. Like reference numerals designate like elements throughout the specification.

Throughout the specification and claims, unless explicitly described to the contrary, the word “comprise”, and variations thereof, such as “comprises” or “comprising”, should be understood to imply the inclusion of stated elements but not the exclusion of any other elements. The same applies to terms such as “have” and “include, and variations thereof. It should be understood that, although the terms first, second, etc. may be used herein to describe various elements, these elements should not be limited by these terms. These terms are only used to distinguish one element from another.

The terms “part”, “unit”, “module”, and the like described in the specification may refer to a unit capable of processing at least one function or operation described in this specification and may be implemented by hardware or circuit, software, or a combination of a hardware or circuit and software. In addition, at least some components or functions of the method and refrigerator failure detection device according to the example embodiments described below may be implemented as a program or software, and the program or software may be stored in a computer-readable medium.

When a component, device, element, module, or the like of the present disclosure is described as having a purpose or performing an operation, function, or the like, the component, device, element, module, or the like should be considered herein as being “configured to” meet that purpose or to perform that operation or function. Each component, device, element, module, or the like may separately embody or be included with a processor and a memory, such as a non-transitory computer readable media, as part of the component, device, element, module, or the like.

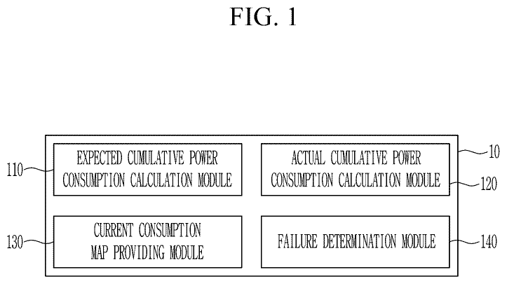

FIG. 1 is a block diagram illustrating a refrigerator failure detection device according to an example embodiment.

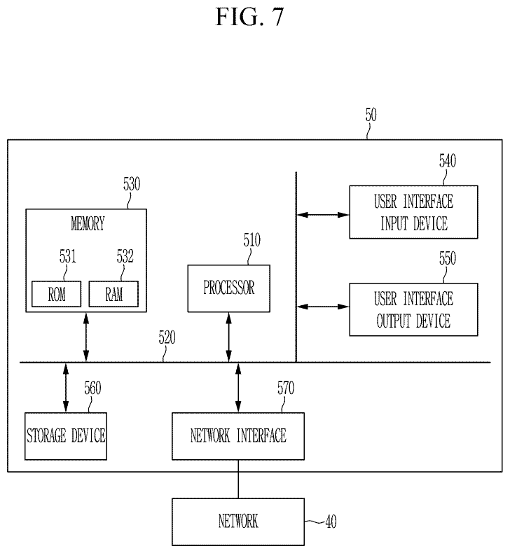

Referring to FIG. 1, a refrigerator failure detection device 10 according to an example embodiment may execute program code loaded in one or more memory devices through one or more processors. For example, the refrigerator failure detection device 10 may be implemented as a computing device 50, as described below with reference to FIG. 7. In this case, one or more processors may correspond to a processor 510 of the computing device 50 and one or more memory devices may correspond to a memory 520 of the computing device 50. The program code may be executed by one or more processors to detect a failure of a refrigerator installed in a vehicle, even while the vehicle is in operation, without relying on a refrigeration temperature sensor. In this specification, the term “module” is used to logically divide these functions performed by the program code.

The refrigerator failure detection device 10 according to an example embodiment may execute program code including an expected cumulative power consumption calculation module 110, an actual cumulative power consumption calculation module 120, a current consumption map providing module 130, and a failure determination module 140.

The expected cumulative power consumption calculation module 110 may obtain expected current consumption of the refrigerator based on a current consumption map predefined for the refrigerator. In addition, the expected cumulative power consumption calculation module 110 may calculate expected cumulative power consumption based on the obtained expected current consumption.

In some example embodiments, the expected cumulative power consumption calculation module 110 may use a correction factor to consider the amount of cargo loaded in the refrigerator. Specifically, the expected cumulative power consumption calculation module 110 may additionally apply a correction factor to the expected current consumption obtained from the current consumption map and may calculate the expected cumulative power consumption based on the expected current consumption to which the correction factor is applied.

In some example embodiments, the correction factor may be calculated according to the following equation:

Correction factor=Weight of refrigerated cargo volume/Basic weight used when creating current consumption map Equation 1

In other words, considering the weight of the refrigerated cargo volume loaded in the refrigerator, a final amount of current required per hour may be calculated by multiplying a refrigerator operating current amount per unit weight by the correction factor.

In some example embodiments, the expected cumulative power consumption calculation module 110 may calculate the expected cumulative power consumption by calculating the expected current consumption obtained from the current consumption map or the expected current consumption to which the correction factor is additionally applied in real time by an operating time of the refrigerator.

The actual cumulative power consumption calculation module 120 may obtain a real-time current consumption of the refrigerator through a current sensor installed in the power supply unit of the refrigerator. In addition, the actual cumulative power consumption calculation module 120 may calculate an actual cumulative power consumption based on the obtained real-time current consumption.

In some example embodiments, the actual cumulative power consumption calculation module 120 may calculate the actual cumulative power consumption by accumulating the real-time current consumption in real time by the operating time of the refrigerator.

The current consumption map providing module 130 may provide a current consumption map to enable the expected cumulative power consumption calculation module 110 to obtain the expected current consumption of the refrigerator. The current consumption map may include the amount of current required to achieve a target internal temperature of the refrigerator by considering various situations in which the refrigerator vehicle operates.

In some example embodiments, in the current consumption map, a current amount required to achieve the target internal temperature of the refrigerator is defined based on at least one of an external temperature of the refrigerator, an internal temperature of the refrigerator, a target internal temperature of the refrigerator, a type of cargo loaded into the refrigerator (i.e., the refrigerated space in the vehicle), or any combination thereof. The reason why the type of cargo is considered is because detailed specifications, including heat capacity, are different depending on the type of cargo (e.g., ice cream, frozen fish, frozen processed food, etc.). In some example embodiments, the current consumption map may include a current amount defined based on a difference in temperature between external air and internal air calculated using an external temperature and an internal temperatures of the refrigerator. Here, the current amount may be expressed as the amount of current per hour, and the unit may be, for example, ampere per hour (A/h). The expected cumulative power consumption calculation module 110 may obtain a current amount corresponding to a situation by searching the current consumption map using at least one of the difference in temperature between external air and internal air of the refrigerator, a target internal temperature of the refrigerator, the type of cargo loaded in the refrigerated vehicle when the refrigerator vehicle operates, or any combination thereof.

In some example embodiments, the current consumption map may be implemented with a specific data structure. Specifically, the current consumption map is a data structure in the form of a three-dimensional array and may be defined based on a difference between an internal temperature of the refrigerator and an external temperature of the refrigerator as an X-axis, a target internal temperature of the refrigerator as a Y-axis, and a type of cargo loaded into the refrigerator as a Z-axis. The expected cumulative power consumption calculation module 110 may obtain the current amount corresponding to a driving situation of the refrigeration vehicle by searching the current consumption map including the X-axis, Y-axis, and Z-axis.

The current consumption map may be loaded in the memory device along with program code including the expected cumulative power consumption calculation module 110, the actual cumulative power consumption calculation module 120, the current consumption map providing module 130, and the failure determination module 140 and may be accessed.

The current consumption map may be configured through theoretical techniques or may be configured through experimental techniques. When the current consumption map is configured through theoretical techniques, a heat loss amount of the refrigerator structure may be calculated through analysis of the refrigerator of the vehicle, a cooling amount of the refrigerator may be calculated, and a net cooling amount may be derived from a difference between the heat loss amount and the cooling amount. After net power for lowering a unit temperature per unit time is calculated, the amount of power required to achieve the target temperature may be calculated to determine the expected current consumption of the current consumption map. When the current consumption map is configured through experimental techniques, an artificial temperature difference condition inside and outside the refrigerator of the vehicle in a test facility may be formed. Also, time and power required to achieve the target temperature may be measured by operating the refrigerator to determine the expected current consumption of the current consumption map. In particular, the current consumption map is configured to have different expected current consumption values depending on the type of cargo loaded into the refrigerator. For example, frozen fish has a high density and ice cream has a high air content to have a relatively low density. Thus, the different expected current consumption values are to reflect unique characteristics of cargo. As another example, semi-dry products have relative low moisture content. Thus, a more detailed expected current consumption value may be set by considering the unique characteristics of the cargo. Accordingly, the accuracy of determining whether the refrigerator is broken may be further improved.

The failure determination module 140 may compare a difference between the expected cumulative power consumption calculated from the expected cumulative power consumption calculation module 110 and the actual cumulative power consumption calculated from the actual cumulative power consumption calculation module 120 with a predetermined error tolerance to determine whether the refrigerator is broken.

In some example embodiments, the error tolerance may be obtained based on an error map for each predefined power consumption section. In the error map for each power consumption section, an error tolerance defined for each cumulative power consumption section is defined based on the cumulative power consumption of the refrigerator.

The error map for each power consumption section may be loaded to the memory device along with program code including the expected cumulative power consumption calculation module 110, the actual cumulative power consumption calculation module 120, the current consumption map providing module 130, and the failure determination module 140 and may be accessed.

Specifically, the failure determination module 140 may determine that the refrigerator is normal when the difference (for example, an absolute value of the difference) between the expected cumulative power consumption and the actual cumulative power consumption is less than the error tolerance. If the difference between the expected cumulative power consumption and the actual cumulative power consumption is greater than or equal to the error tolerance, the failure determination module 140 may determine that the refrigerator is broken and may output a notification requesting inspection of the refrigerator through a plurality of interfaces such as, for example, instrument clusters, a center fascia, etc. installed in the vehicle. In this specification, the expression of determining that the refrigerator is broken may also include suspecting that the refrigerator is broken.

In this manner, obtaining the expected cumulative power consumption and actual cumulative power consumption and determining whether the refrigerator is normal based thereon may be repeatedly performed at a predetermined period.

In the related art, it was common to detect a failure of a refrigerator using a refrigeration temperature sensor or refrigeration thermometer installed inside the refrigerator of a vehicle. However, this method cannot consider the possibility of an error in the sensor or thermometer itself, or the possibility of an error depending on an installation location of the sensor or thermometer. Therefore, false positive or false negative results may occur as in a case in which the refrigerator is detected to be broken due to a malfunction of the thermometer itself even though the temperature inside the refrigerator is normal or, as in a case in which the temperature inside the refrigerator is not normal but the refrigerator is detected to operate normally due to malfunction of the thermometer. In addition, because it is difficult to determine whether the cause of the failure was due to the refrigeration thermometer or the refrigerator, if an abnormality in the refrigeration thermometer occurs while the vehicle is in operation, the vehicle should be urgently moved to a repair shop and another refrigeration vehicle should be prepared to replace the vehicle with the abnormality. This can result in heavy economic and time losses for companies providing logistics or cargo services or vehicle drivers. If both the refrigerator and the refrigeration thermometer are broken and the broken refrigeration thermometer accidentally indicates a temperature in a normal range, the failure of the refrigerator cannot be detected in the case of relying only on the refrigeration temperature sensor. Thus, there is a high risk of damage to refrigerated cargo. According to the present example embodiment, a failure of the refrigerator is detected based on power consumption used for refrigeration without relying on the refrigeration temperature sensor. Thus, the above problems may be solved, and a failure of the refrigerator may be accurately detected even when the refrigeration vehicle is in operation. In addition, it is possible to detect a failure of the refrigerator at an early stage and ensure the transportation quality of refrigerated cargo.

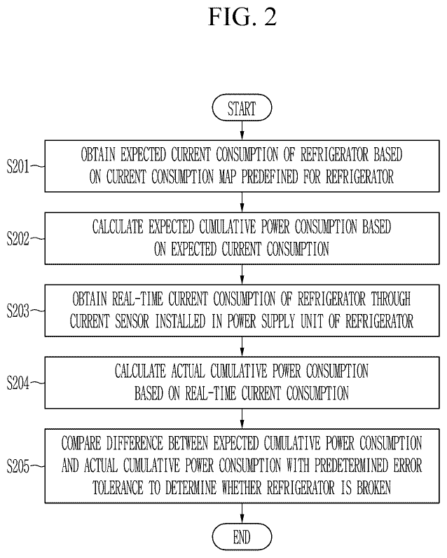

FIG. 2 is a flowchart illustrating a refrigerator failure detection method according to an example embodiment.

Referring to FIG. 2, the refrigerator failure detection method according to an example embodiment may include obtaining expected current consumption of the refrigerator based on a current consumption map predefined for the refrigerator (operation S201) and calculating an expected cumulative power consumption based on the expected current consumption (operation S202). The method may also include obtaining real-time current consumption of the refrigerator through a current sensor installed in the power supply unit of the refrigerator (operation S203) and calculating actual cumulative power consumption based on the real-time current consumption (operation S204). The method may further include comparing a difference between the expected cumulative power consumption and the actual cumulative power consumption with a predetermined error tolerance to determine whether the refrigerator is broken (S205).

For more detailed information on the refrigerator failure detection method, the example embodiments described in this specification may be referred to, so redundant description have been omitted here.

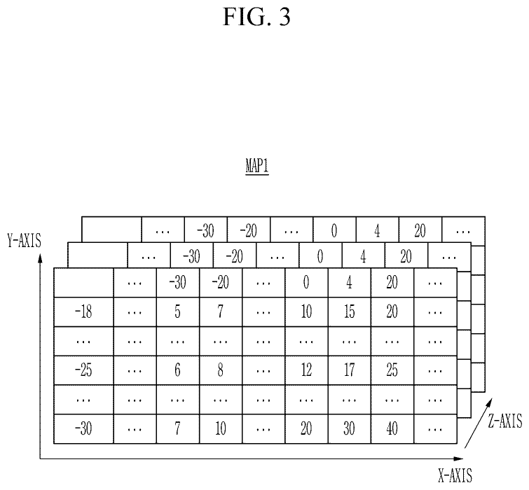

FIG. 3 is a diagram illustrating an implementation example of a refrigerator failure detection device according to an example embodiment.

Referring to FIG. 3, in the refrigerator failure detection device according to an example embodiment, a current consumption map MAP1 may be implemented as a three-dimensional array-type data structure. Specifically, the current consumption map MAP1 may include current amounts defined based on X-axis data representing a difference between an internal temperature and an external temperature of the refrigerator, Y-axis data representing a target internal temperature of the refrigerator, and Z-axis data representing the type of cargo loaded into the refrigerator. For example, if a temperature difference between inside and outside air is 4 degrees, the target internal temperature of the refrigerator is −25° C., and the type of cargo loaded into the refrigerator is frozen processed food, the expected current consumption of the refrigerator corresponding to the situation may be obtained as 17 amps per hour from the current consumption map MAP1. As another example, if a temperature difference between inside and outside air is 4 degrees, the target internal temperature of the refrigerator is −30° C., and the type of cargo loaded into the refrigerator is frozen processed food, the expected current consumption of the refrigerator corresponding to the situation may be obtained as 30 amps per hour from the current consumption map MAP1. In other words, as the target internal temperature is lower, the expected current consumption may increase.

As another example, if a temperature difference between inside and outside air is −20 degrees, the target internal temperature of the refrigerator is −25° C., and the type of cargo loaded into the refrigerator is frozen processed food, the expected current consumption of the refrigerator corresponding to the situation may be obtained as 8 amps per hour from the current consumption map MAP1. As another example, if the type of cargo loaded into the refrigerator is frozen fish, the expected current consumption may be set to a different value than when the type of cargo is frozen processed food in the same X-axis data and Y-axis data.

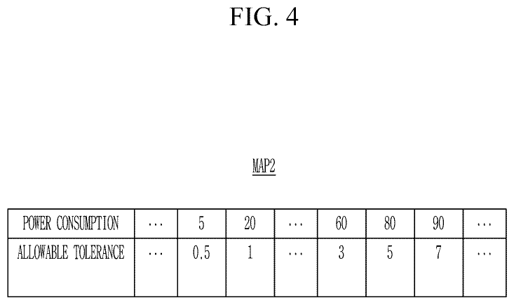

FIG. 4 is a diagram illustrating an implementation example of a refrigerator failure detection device according to an example embodiment.

Referring to FIG. 4, in the refrigerator failure detection device according to an example embodiment, an error map MAP2 for each power consumption section may be set so that an error tolerance for each cumulative power consumption section varies depending on the cumulative power consumption. For example, when the cumulative power consumption is 5, the error tolerance for each cumulative power consumption section may be set to 0.5, when the cumulative power consumption is 20, the error tolerance for each cumulative power consumption section may be set to 1, and when the cumulative power consumption is 60, the error tolerance for each cumulative power consumption section may be set to 3. In other words, as the cumulative power consumption increases, the error tolerance for each cumulative power consumption section may be set to a larger value.

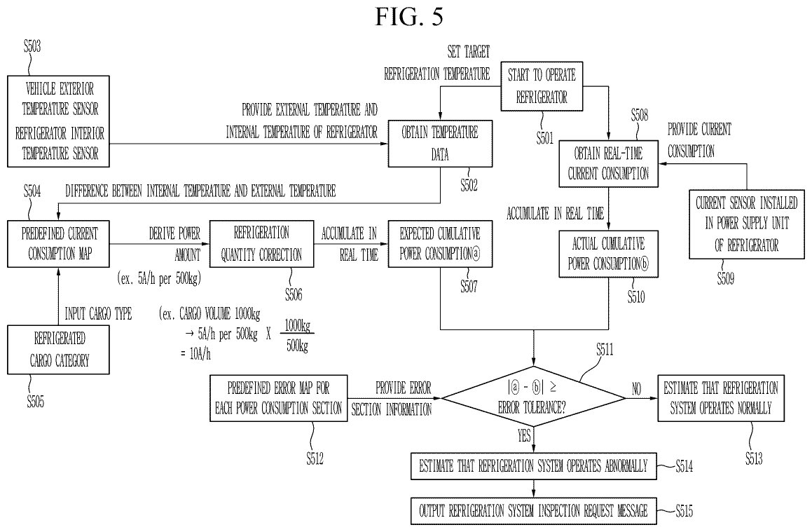

FIG. 5 is a diagram illustrating an implementation example of a refrigerator failure detection device according to an example embodiment.

Referring to FIG. 5, in the refrigerator failure detection device according to an example embodiment, an operation of a refrigerator may start in operation S501.

A target refrigeration temperature may be set as soon as the refrigerator starts operating, and temperature data may be acquired in operation S502. Temperature data may include data regarding an external temperature and internal temperature of the refrigerator. These data may be obtained from a vehicle exterior temperature sensor and a refrigerator interior temperature sensor, as in operation S503. In operation S502, a difference between an internal temperature of the refrigerator and an external temperature may be calculated from the acquired temperature data.

In operation S504, expected current consumption may be derived from a predefined current consumption map according to the difference between the internal temperature of the refrigerator and the external temperature and the type of cargo. Here, the type of cargo may be determined by considering the type of refrigerated cargo, as in operation S505. Subsequently, in operation S506, refrigeration quantity correction may be performed using a correction factor. For example, if the expected current consumption derived in operation S504 is 5 A/h per 500 kg, 10 A/h of expected current consumption may be obtained by applying a correction factor of 2 (=1000 kg/500 kg) considering that the cargo volume is 1000 kg. Next, in operation S507, expected cumulative power consumption may be calculated by accumulating the obtained expected current consumption in real time by an operating time of the refrigerator.

With the start of operation of the refrigerator, real-time current consumption may be obtained in operation S508. The real-time current consumption may be obtained from a current consumption value provided from a current sensor installed in a power supply unit of the refrigerator, as in operation S509. Next, in operation S510, actual cumulative power consumption may be calculated by accumulating the obtained real-time current consumption in real time by the operating time of the refrigerator.

In operation S511, the difference between the expected cumulative power consumption calculated in operation S507 and the actual cumulative power consumption calculated in operation S510 may be compared with a predetermined error tolerance. Specifically, it may be determined whether an absolute value of the difference between the expected cumulative power consumption calculated in operation S507 and the actual cumulative power consumption calculated in operation S510 is greater than or equal to the error tolerance. At this time, as in operation S512, this may be obtained based on an error map for each predefined power consumption section and information on the corresponding error section may be provided as an error tolerance.

If the difference between the expected cumulative power consumption and the actual cumulative power consumption is less than the error tolerance (NO in operation S511), it may be assumed that the refrigeration system (i.e., the refrigerator) operates normally as in operation S513. Alternatively, if the difference between the expected cumulative power consumption and the actual cumulative power consumption is greater than the error tolerance (YES in operation S511), it may be estimated that the refrigeration system (i.e., the refrigerator) operates abnormally as in operation S514. In this case, as in operation S515, a message requesting inspection of the refrigeration system may be displayed in the vehicle.

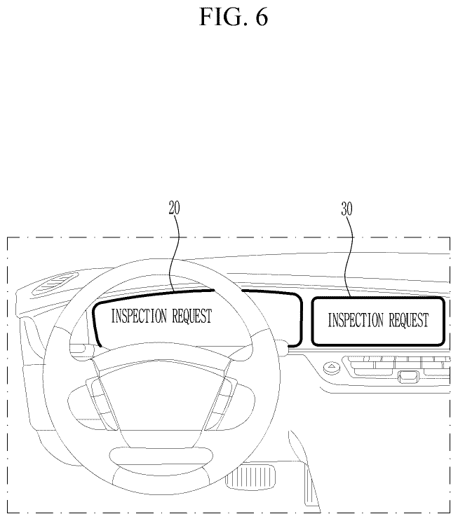

FIG. 6 is a diagram illustrating an implementation example of a refrigerator failure detection device according to an example embodiment.

Referring to FIG. 6, in the refrigerator failure detection device according to an example embodiment, if the difference between the expected cumulative power consumption and the actual cumulative power consumption is equal to or greater than the error tolerance, it may be determined that the refrigerator is broken. At this time, a notification requesting inspection of the refrigerator may be output through a plurality of interfaces, such as an instrument cluster 20 and/or a center fascia 30, installed in the vehicle. Accordingly, a failure of the refrigerator may be detected at an early stage when driving the vehicle, and the transportation quality of refrigerated cargo may be secured.

FIG. 7 is a diagram illustrating a computing device according to an example embodiment.

Referring to FIG. 7, a refrigerator failure detection method and device according to example embodiments may be implemented using a computing device 50.

The computing device 50 may include at least one of a processor 510, a memory 530, a user interface input device 540, a user interface output device 550, and a storage device 560 communicating with each other via a bus 520. The computing device 50 may also include a network interface 570 electrically connected to a network 40. The network interface 570 may transmit or receive signals to and from other entities through the network 40.

The processor 510 may be implemented as various types, such as a micro controller unit (MCU), an application processor (AP), a central processing unit (CPU), a graphic processing unit (GPU), a neural processing unit (NPU), and/or a quantum processing unit (QPU). The processor 510 may be a semiconductor device that executes instructions stored in the memory 530 or the storage device 560. The processor 510 may be configured to implement the functions and methods described above with respect to FIGS. 1-6.

The memory 530 and the storage device 560 may include various types of volatile or non-volatile storage mediums. For example, the memory may include read-only memory (ROM) 531 and random access memory (RAM) 532. In some example embodiments, the memory 530 may be located inside or outside the processor 510 and the memory 530 may be connected to the processor 510 through various known units.

In some example embodiments, at least some components or functions of the refrigerator failure detection method and device according to the example embodiments may be implemented as a program or software running on the computing device 50, and the program or software may be stored in a computer-readable medium. Specifically, the computer-readable medium according to an example embodiment may record a program for executing the operations included in the refrigerator failure detection method and device according to the example embodiments on a computer including the processor 510 that executes a program or command stored in the memory 530 or the storage device 560.

In some example embodiments, at least some components or functions of the refrigerator failure detection method and device according to example embodiments may be implemented using hardware or circuits of the computing device 50 or may be implemented using separate hardware or circuits that may be electrically connected to the computing device 50.

In the related art, even if an abnormality was detected in a refrigeration temperature sensor, for example, a refrigeration thermometer during an operation of a vehicle, it was difficult to determine whether a cause of the failure was due to the refrigeration thermometer or the refrigerator. Therefore, if an abnormality in the refrigeration thermometer occurred while the vehicle was in operation, the vehicle should be urgently moved to a repair shop and another refrigeration vehicle should be prepared to replace the corresponding vehicle. This could result in heavy economic and time losses for companies providing logistics or cargo services or vehicle drivers. Meanwhile, if both the refrigerator and the refrigeration thermometer are broken and the broken refrigeration thermometer accidentally indicates a temperature in a normal range, the failure of the refrigerator cannot be detected in the case of relying only on a refrigeration temperature sensor. Thus, there is a high risk of damage to refrigerated cargo.

According to example embodiments of the present disclosure, a failure of the refrigerator is detected based on power consumption used for refrigeration without relying on the refrigeration temperature sensor. The foregoing problems are thereby solved, and a failure of the refrigerator is accurately detected, even while the refrigeration vehicle is in operation. In addition, it is possible to detect a failure of a refrigerator at an early stage and to ensure transportation quality of refrigerated cargo.

While the technical concepts of the present disclosure have been described in connection with example embodiments, it is to be understood that the disclosure is not limited to the various example embodiments. On the contrary, the present disclosure is intended to cover various modifications and equivalent arrangements included within the spirit and scope of the appended claims.

What is claimed is:

1. A method for detecting a failure of a refrigerator installed in a vehicle, the method comprising:
obtaining expected current consumption of the refrigerator based on a current consumption map predefined for the refrigerator;
calculating an expected cumulative power consumption based on the expected current consumption;
obtaining real-time current consumption of the refrigerator through a current sensor installed in the power supply unit of the refrigerator;
calculating actual cumulative power consumption based on the real-time current consumption; and
comparing a difference between the expected cumulative power consumption and the actual cumulative power consumption with a predetermined error tolerance to determine whether the refrigerator is broken.

2. The method of claim 1, wherein, in the current consumption map, a current amount required to achieve the target internal temperature of the refrigerator is defined based on at least one of an external temperature of the refrigerator, an internal temperature of the refrigerator, a target internal temperature of the refrigerator, a type of cargo loaded into the refrigerator, or any combination thereof.

3. The method of claim 2, wherein the current consumption map is defined based on a difference between the internal temperature of the refrigerator and the external temperature of the refrigerator as an X-axis, the target internal temperature of the refrigerator as a Y-axis, and the type of cargo loaded into the refrigerator as a Z-axis.

4. The method of claim 1, wherein calculating the expected cumulative power consumption comprises:
applying a correction factor for considering a cargo volume loaded in the refrigerator to the expected current consumption and calculating the expected cumulative power consumption based on the expected current consumption to which the correction factor is applied.

5. The method of claim 1, wherein calculating the expected cumulative power consumption comprises:
calculating the expected cumulative power consumption by accumulating the expected current consumption in real time by an operating time of the refrigerator.

6. The method of claim 1, wherein calculating the actual cumulative power consumption comprises:
calculating the actual cumulative power consumption by accumulating the real-time current consumption in real time by an operating time of the refrigerator.

7. The method of claim 1, wherein the error tolerance is obtained based on an error map for each predefined power consumption section.

8. The method of claim 7, wherein, in the error map for each power consumption section, an error tolerance is defined for each cumulative power consumption section based on the cumulative power consumption of the refrigerator.

9. The method of claim 1, wherein determining whether the refrigerator is broken comprises:
when the difference between the expected cumulative power consumption and the actual cumulative power consumption is less than the error tolerance, determining that the refrigerator is normal.

10. The method of claim 1, wherein determining whether the refrigerator is broken comprises:
when the difference between the expected cumulative power consumption and the actual cumulative power consumption is greater than or equal to the error tolerance, determining that the refrigerator is broken; and
outputting a notification requesting inspection of the refrigerator through a plurality of interfaces installed in the vehicle.

11. A device for detecting a failure of a refrigerator installed in a vehicle, the device configured to execute a program code loaded in one or more memory devices through one or more processors, wherein the program code is executed to:
obtain expected current consumption of the refrigerator based on a current consumption map predefined for the refrigerator;
calculate an expected cumulative power consumption based on the expected current consumption;
obtain real-time current consumption of the refrigerator through a current sensor installed in the power supply unit of the refrigerator;
calculate actual cumulative power consumption based on the real-time current consumption; and
compare a difference between the expected cumulative power consumption and the actual cumulative power consumption with a predetermined error tolerance to determine whether the refrigerator is broken.

12. The refrigerator failure detection device of claim 11, wherein, in the current consumption map, a current amount required to achieve the target internal temperature of the refrigerator is defined based on at least one of an external temperature of the refrigerator, an internal temperature of the refrigerator, a target internal temperature of the refrigerator, a type of cargo loaded into the refrigerator, or any combination thereof.

13. The refrigerator failure detection device of claim 12, wherein the current consumption map is defined based on a difference between the internal temperature of the refrigerator and the external temperature of the refrigerator as an X-axis, the target internal temperature of the refrigerator as a Y-axis, and the type of cargo loaded into the refrigerator as a Z-axis.

14. The refrigerator failure detection device of claim 11, wherein calculating the expected cumulative power consumption comprises:
applying a correction factor for considering a cargo volume loaded in the refrigerator to the expected current consumption and calculating the expected cumulative power consumption based on the expected current consumption to which the correction factor is applied.

15. The refrigerator failure detection device of claim 11, wherein calculating the expected cumulative power consumption comprises:
calculating the expected cumulative power consumption by accumulating the expected current consumption in real time by an operating time of the refrigerator.

16. The refrigerator failure detection device of claim 11, wherein calculating the actual cumulative power consumption comprises:
calculating the actual cumulative power consumption by accumulating the real-time current consumption in real time by an operating time of the refrigerator.

17. The refrigerator failure detection device of claim 11, wherein the error tolerance is obtained based on an error map for each predefined power consumption section.

18. The refrigerator failure detection device of claim 17, wherein, in the error map for each power consumption section, an error tolerance is defined for each cumulative power consumption section based on the cumulative power consumption of the refrigerator.

19. The refrigerator failure detection device of claim 11, wherein determining whether the refrigerator is broken comprises:
when the difference between the expected cumulative power consumption and the actual cumulative power consumption is less than the error tolerance, determining that the refrigerator is normal.

20. The refrigerator failure detection device of claim 11, wherein determining whether the refrigerator is broken comprises:
when the difference between the expected cumulative power consumption and the actual cumulative power consumption is greater than or equal to the error tolerance, determining that the refrigerator is broken; and
outputting a notification requesting inspection of the refrigerator through a plurality of interfaces installed in the vehicle.
